(19) United States
(12) Patent Application Publication
(10) Pub. No.: US 2002/0171742 A1
(43) Pub. Date: Nov. 21, 2002

(54) Method and apparatus for controlling a view field of an image picking-up apparatus and computer program therefor

(76) Inventors: Wataru Ito, Kodaira (JP); Hirotada Ueda, Kokubunji (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/105,169

(22) Filed: Mar. 26, 2002

(30) Foreign Application Priority Data
Mar. 30, 2001 (JP) 2001-099318

(51) Int. Cl. H04N 5/232

(52) U.S. Cl. 348/211.99

(57) ABSTRACT

An apparatus for manipulating a view field of an image picking-up apparatus using a manual manipulator. An image input interface converts video signal from the image picking-up apparatus to image data. An image memory stores the image data. An image processing unit processes the image data. A display unit displays the image data as an image with a manipulation marker superposed thereon at a position indicated by the manipulator. A controller controls the view field of the image picking-up apparatus using signals from the image processing unit. The manipulator moves the manipulation marker displayed on the image, and the image processing unit calculates a control amount of the view field based on position coordinates of the manipulation marker and controls the view field according to the control amount.

### BACKGROUND OF THE INVENTION

The present invention relates to an image picking-up apparatus' view field control apparatus, and more particularly to a view-field controlling method, apparatus, and computer program that control the view field of an image picking-up apparatus based on an manipulation marker moving on an image and on the position of the manipulation marker.

Referring to FIG. 5, a first prior art will be described. FIG. 5 is a diagram showing the overview of an operation that is performed to control a view-field control apparatus such as a pan and tilt head when the view field of an image picking-up apparatus such as a camera is controlled by the view-field control apparatus mounted on the image picking-up apparatus. The pan and tilt head is also known as a pan tilt head or a pan-tilt head. In this prior art, the direction of the view field of the image picking-up apparatus such as a camera is controlled in accordance with the manipulation of manipulation means. That is, a camera pan and tilt head manipulation apparatus operates the camera pan and tilt head, which is an electrically operated swivel, in accordance with the manipulation of the manipulation means and changes the pan angle and/or the tilt angle of a camera mounted on the camera pan and tilt head to control the direction of the view field of the camera.

Referring to FIG. 5, a guard (operator) operates a camera pan and tilt head 503 using a camera pan and tilt head manipulation apparatus 504 and manipulation means 505 such as a joystick, while watching a camera video image 507 displayed on the screen of a display such as a monitor, to control the direction of a view field of a camera 503a. In this way, the operator monitors an intruding object 502 that has intruded into a tank yard site 501. In FIG. 5, a camera 503a and the camera pan and tilt head 503 are shown as one figure.

The camera 503a mounted on the camera pan and tilt head 503 obtains an image in the view field range (camera view field 506) with the camera view field direction as the center and sends the obtained image to the camera pan and tilt head manipulation apparatus 504. The camera pan and tilt head manipulation apparatus 504 displays the received image as the camera video image 507 on the screen of the monitor provided internally or externally on the camera pan and tilt head manipulation apparatus 504. In this example, the camera pan and tilt head manipulation apparatus 504 has the function of transferring the image picked up by the camera 503a to other units.

When the guard watches the camera video image 507 and finds that the intruding object 502 has intruded into the tank yard site 501, he or she manipulates the manipulation means 505. The manipulation means 505 generates a manipulation signal (for example, signal indicating a manipulation direction) according to the operation performed by the guard and sends the manipulation signal to the camera pan and tilt head manipulation apparatus 504. The camera pan and tilt head manipulation apparatus 504 generates a control signal based on the received manipulation signal and sends it to the camera pan and tilt head 503. The camera pan and tilt head 503 controls the pan motor and the tilt motor of the camera pan and tilt head 503 based on the received control signal to change the camera view direction (angle of view field) of the camera 503a.

The camera view field 506 is changed according to the change in the angle of camera field, and the camera video image 507 is changed. That is, because the direction of camera view field of the camera 503a is changed, the camera video image 507 obtained by the camera 503a is changed.

At this time, the angle of revolution (control amount) of the pan motor that changes the pan angle and that of the tilt motor that changes the tilt angle during the control signal is in “ON” state are set, for example, to 20°/sec, respectively, by the camera pan and tilt head manipulation apparatus 504. This control amount may be adjusted by the manipulation buttons provided on the manipulation means 505 (In the example of FIG. 5, the manipulation means 505 has two buttons, 505a and 505b).

For example, the control amount is set to 10°/sec when the operator manipulates the manipulation means 505 with the button 505a held, and is set to 40°/sec when the operator manipulates the manipulation means 505 with the button 505b held. In this way, the pan motor and the tilt motor of the camera pan and tilt head 503 may be controlled finely or coarsely. When the operator manipulates the manipulation means 505 with neither button held, the pan motor and the tilt motor may be turned with the control amount of 20°/sec.

Therefore, according to the first prior art described above, the operator operates the manipulation means to change the image picking-up view field angle of the image picking-up apparatus, such as a camera, to change the direction of the view field of the camera.

Next, referring to FIG. 5 and FIG. 6, an image picking-up apparatus' view-field control apparatus according to a second prior art will be described. This manipulation apparatus has manipulation means that controls the direction of the view field of a camera by allowing the operator to select camera pan and tilt head manipulation buttons, such as a direction button displayed on the screen, with the use of a pointing device such as a mouse. FIG. 6 is a diagram showing the overview of the display screen (manipulation screen) of a camera pan and tilt head manipulation apparatus. On this display screen such as a monitor, the camera pan and tilt head manipulation button figures are superposed on a camera image 602 (camera image 507 in FIG. 5) are displayed.

In the second prior art, the apparatus has the configuration similar to that shown in FIG. 5 (tank yard site 501, intruding object 502, camera 503a and camera pan and tilt head 503, camera pan and tilt head manipulation apparatus 504, and manipulation means 505) except that a manipulation screen 601 shown in FIG. 6 is provided instead of the camera video image 507 in FIG. 5.

Referring to FIG. 6, not only the camera image 602 but also a manipulation marker 603 that moves on the screen according to the manipulation of the manipulation means 505 and GUI (Graphical User Interface) manipulation buttons 604-610 specifically provided for operating the camera pan and tilt head 503 are displayed on the manipulation screen 601. As the stick of the manipulation means 505 is tilted in upward, downward, left, and right directions, the manipulation marker 603 also moves in the upward, downward, left, and right directions. Furthermore, when the stick of the manipulation means 505 is tilted in the upper-left direction, the manipulation marker 603 also moves in the upper-left direction. The operator uses the manipulation means 505 in this way to move the manipulation marker 603 freely on the manipulation screen 601.

In addition, the manipulation means 505 has at least one button that allows the operator to give a command to objects other than the manipulation marker 603. When the operator presses this button, the camera pan and tilt head manipulation apparatus 504 can sense that the button is pressed. Upon sensing that the button is pressed, the camera pan and tilt head manipulation apparatus 504 checks if there is one of GUI manipulation buttons, 604-610, in the direction of the manipulation marker 603 and, if there is, considers that the manipulation button has been pressed virtually. In this way, the operator can press the GUI manipulation buttons 604-610 on the manipulation screen freely.

Each of the GUI manipulation buttons, 604-610, is assigned a specific operation. For example, when the upward button 604 is pressed, the camera pan and tilt head manipulation apparatus 504 moves the camera view-field direction upward a predetermined amount (causes the tilt motor to move the camera view field upward a predetermined amount) and, when the downward button 605 is pressed, moves the camera view-field direction downward a predetermined amount (causes the tilt motor to move the camera view field downward a predetermined amount). Similarly, when the left button 606 is pressed, the camera pan and tilt head manipulation apparatus 504 moves the camera view-field direction to the left a predetermined amount (causes the pan motor to move the camera view field to the left a predetermined amount) and, when the right button 607 is pressed, moves the camera view-field direction to the right a predetermined amount (causes the pan motor to move the camera view field to the right a predetermined amount).

The predetermined amounts controlled by the pan motor and the tilt motor are set by the control amount specification buttons 608-610. When one of the buttons 604-607 is pressed with the low-speed (×½) button 608 held, the control amounts of the pan motor and the tilt motor are set finely, for example, to 10°/sec. When the button is pressed with the intermediate-speed (×1) button 609 held, the control amounts of the pan motor and the tilt motor are set intermediately, for example, to 20°/sec. When the button is pressed with the high-speed (×2) button 610 held, the control amounts of the pan motor and the tilt motor are set coarsely, for example, to 40°/sec. In this way, the camera view field direction of the camera 503a may be controlled freely.

Therefore, according to the second prior art described above, when the operator uses the manipulation means 505 to manipulate the manipulation marker 603 on the manipulation screen 601 and presses one of GUI manipulation buttons 604-610, the direction of view field of the image picking-up apparatus may be controlled accordingly.

### SUMMARY OF THE INVENTION

In the prior arts described above, the operator can control the direction of view field of an image picking-up apparatus. However, the problem with the first and the second prior arts is that the control amount of the pan motor and the tilt motor may be set only to a fixed rate (rotation speed) (for example, the control amount may be set with the buttons 505a and 505b in FIG. 5, and with the GUI manipulation buttons 608-610 in FIG. 6) and therefore the rotation speed of the pan angle and the tilt angle cannot be changed to a desired amount. That is, the camera view field direction cannot be changed freely according to the speed of an intruding object.

In the second prior art, the GUI manipulation buttons are used for movement in upward, downward, left, or right direction. Therefore, when the guard (operator) watches the camera image 602 and wants to move the camera view field, for example, into the upward direction, he or she must place the manipulation marker in the upward button 604 and then press the button. This requires the operator to watch both the camera video image and the GUI manipulation buttons by moving his or her eyes back and forth, preventing the operator from directly operating the camera pan and tilt head. That is, when the operator does not watch the camera video image while operating the GUI manipulation buttons, there is a possibility that the operator loses sight of the intruding object.

In addition, when the operator tries to watch a particular part into the center of the camera image 602 with the use of the view-field control apparatus, such as a camera pan and tilt head, in the first and second prior arts, the operator must tilt the stick of the manipulation means 505 in the upward, downward, left, or right direction (or move the manipulation marker 603 and press the upward button 604, downward button 605, left button 606, or right button 607 on the view-field-direction manipulation apparatus in the second prior art) to bring the desired part into the center of the camera image 602. This manipulation requires skill.

In summary, a disadvantage with the prior arts is that the control amount of the pan motor or the tilt motor cannot be changed to a desired value. In addition, a disadvantage with the method in which the GUI manipulation buttons are used to control the view field direction of an image picking-up apparatus is that the operator must watch a camera image and the manipulation buttons alternately and therefore cannot control the view-field direction of the image picking-up apparatus while watching the camera video. In addition, the operator must use an image picking-up apparatus' view-field manipulation apparatus to control the view field to the upward, downward, left, or right direction to bring a particular part into the center of the video. This requires skill.

It is an object of the present invention to provide a method and apparatus for controlling the view field of an image picking-up apparatus, which is easy to handle and can change the direction of the view field of an image picking-up apparatus in any control amount, and a computer program therefor.

It is another object of the present invention to provide a method and apparatus for controlling the view field of an image picking-up apparatus, which is easy to handle and can control the direction of the view field of an image picking-up apparatus so that a particular specified part may be displayed on the center of a display screen, and a computer program therefor.

According to one aspect of the invention, there is provided a method for controlling a view field control apparatus of an image picking-up system including an image picking-up apparatus for image picking up an object, a driving mechanism for driving the image picking-up apparatus, a manipulator for controlling a view field of the image picking up apparatus, a display unit and a controlling unit, the method comprising the steps of:

image picking up the object;

manipulating the manipulator to drive the image picking-up apparatus;

displaying a manipulation marker in superposition on the image picked up by the image picking-up apparatus on the display unit, the manipulation marker being manipulated by the manipulator; and

driving the driving mechanism in response to a movement of the manipulation marker,

wherein the view field of the image picking-up apparatus is controlled by manipulation of the manipulator.

Preferably, the step of image picking up the object includes the step of converting an image signal supplied from the image picking-up apparatus to image data, and, the step of driving the driving mechanism in response to a movement of the manipulation marker includes the steps of calculating a control amount for movement of the image picking-up apparatus based on positional coordinates of the manipulation marker and controlling the driving mechanism based on a calculation result.

Preferably, the step of driving the driving mechanism in response to the movement of the manipulation marker includes the step of setting a predetermined threshold value for driving the driving mechanism and the step of driving the driving mechanism when a control amount calculation result for movement of the image picking-up apparatus exceeds the predetermined threshold value.

Preferably, the method has the further step of displaying the predetermined threshold value on the display unit as area information.

Preferably, the method has the further step of controlling such that the manipulation marker manipulated by the manipulator is located at around a center of a display screen of the display unit in initial setting.

Preferably, the method has the further step of controlling a driving speed of the driving mechanism in response to a movement distance of the manipulation marker manipulated by the manipulator.

Preferably, the step of image picking up the object includes the step of storing a predetermined image obtained from the image picking-up apparatus in a storage, as a template image, the predetermined image being designated by the marker, wherein the step of driving the driving mechanism in response to the movement of the manipulation marker includes the steps of detecting coordinates of that part of a predetermined image subsequently obtained from the image picking-up apparatus which is most similar to the template image, calculating a control amount for movement of the image picking-up apparatus based on the detected coordinates and, based on a calculation result, controlling the driving mechanism.

According to another aspect of the invention, there is provided a view field control apparatus of an image picking-up apparatus comprising:

an image picking-up apparatus for image picking-up an object;

a manipulator for controlling a view field of the image picking-up apparatus;

a display unit for displaying an image from the image picking-up apparatus; and

a control unit for controlling the image picking-up apparatus, driving mechanism and display unit, wherein the control unit displays a manipulation marker manipulated by the manipulator in superposition on an image from the image picking-up apparatus and the driving mechanism is driven in response to a movement of the manipulation marker to thereby control the view field of the image picking-up apparatus.

Preferably, the control unit includes an image data conversion unit and an image processing unit, wherein the image data conversion unit converts an image signal supplied from the image picking-up apparatus to image data, the image processing unit calculates a control amount for movement of the image picking-up apparatus based on positional coordinates of the manipulation marker, and the control unit controls the driving mechanism based on the calculation result.

Preferably, the control unit has a means for setting a predetermined threshold value for driving the image picking-up apparatus, wherein when the control amount calculation result exceeds the predetermined threshold value, the control unit drives the driving mechanism.

Preferably, the predetermined threshold value is displayed on the display unit as area information.

Preferably, the control unit controls such that the manipulation marker manipulated by the manipulator is located at around a center of a display screen of the display unit in initial setting.

Preferably, the manipulator is operable with at least one of operator's voice, body gesture, hand gesture and glance direction.

Preferably, the image processing unit stores a predetermined image obtained from the image picking up apparatus in a storage, as a template image, said predetermined image being designated by the manipulation marker, detects positional coordinates of that part of a predetermined image subsequently obtained from the image picking-up apparatus which is most similar to the template image, calculates a control amount for movement of the image picking-up apparatus based on the positional coordinates and, based on a calculation result, controls the driving mechanism.

According to another aspect of the invention, there is provided a computer program product comprising:

a computer usable medium having computer readable program code means embodied therein for controlling a view field control apparatus of an image picking-up system including an image picking-up apparatus for image picking-up an object, a driving mechanism for driving the image picking-up apparatus, a manipulator for controlling a view field of the image picking-up apparatus, a display unit and a control unit, the computer readable program code means comprising:

means for image picking-up an object by the image picking-up apparatus and converting an image signal supplied from the image picking-up apparatus to image data;

means for receiving a signal from a manipulator for controlling a view field of the image picking-up apparatus to drive the image picking-up apparatus;

means for displaying an image picked up by the image picking-up apparatus and a manipulation marker superposed on the image, the manipulation marker being manipulated by the manipulator;

means for calculating a control amount for movement of the image picking-up apparatus based on positional coordinates of the manipulation marker and, based on the calculation result, driving the driving mechanism.

Preferably, the means for driving the driving mechanism in response to a movement of the manipulation marker includes means for setting a predetermined threshold alue for driving the driving mechanism and means for driving the driving mechanism when a control amount calculation result exceeds the predetermined threshold value.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing the processing of view field control of an image picking-up apparatus according to one embodiment of the present invention.

FIG. 2 is a flowchart for explaining another embodiment of the present invention.

FIG. 3 is a flowchart for explaining another embodiment of the present invention.

FIG. 4 is a block diagram showing the configuration of an intruding object monitor when the present invention is applied to the monitoring of an intruding object.

FIG. 5 is a diagram for schematically explaining a conventional intruding object monitoring apparatus.

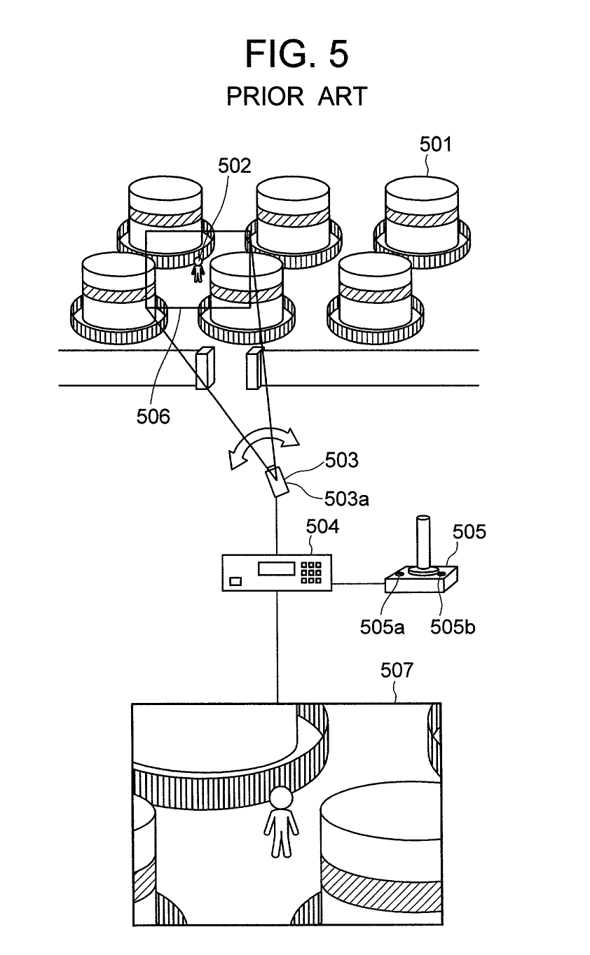

FIG. 6 is a diagram for explaining a manipulation screen for a pan and tilt head for mounting thereon another conventional intruding object monitoring apparatus.

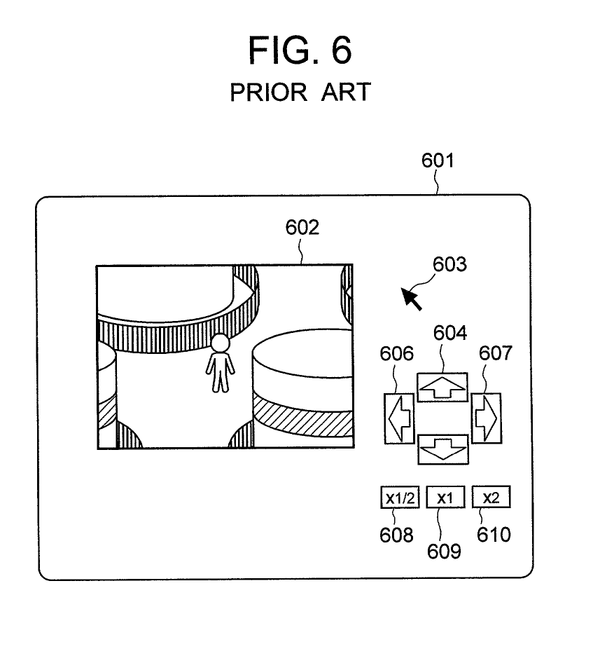

FIGS. 7A and 7B are diagrams showing a template matching method used in a view field manipulation in another embodiment of the present invention.

FIG. 8 is a diagram showing an example of a screen displayed on a display device in one embodiment of the present invention.

FIG. 9 is a diagram showing an example of the relation between the position of a manipulation marker on a camera video and a control amount in one embodiment of the present invention.

FIG. 10 is a diagram showing an example of the relation between the position of a manipulation marker on a camera video and a control amount in another embodiment of the present invention.

FIG. 11 is a diagram showing the contents of a work memory used in the embodiment shown in FIG. 3.

### DETAILED DESCRIPTION OF THE EMBODIMENTS

Some embodiments of the present invention will be described with reference to the drawings. In the drawings, same reference numerals denote same structural elements.

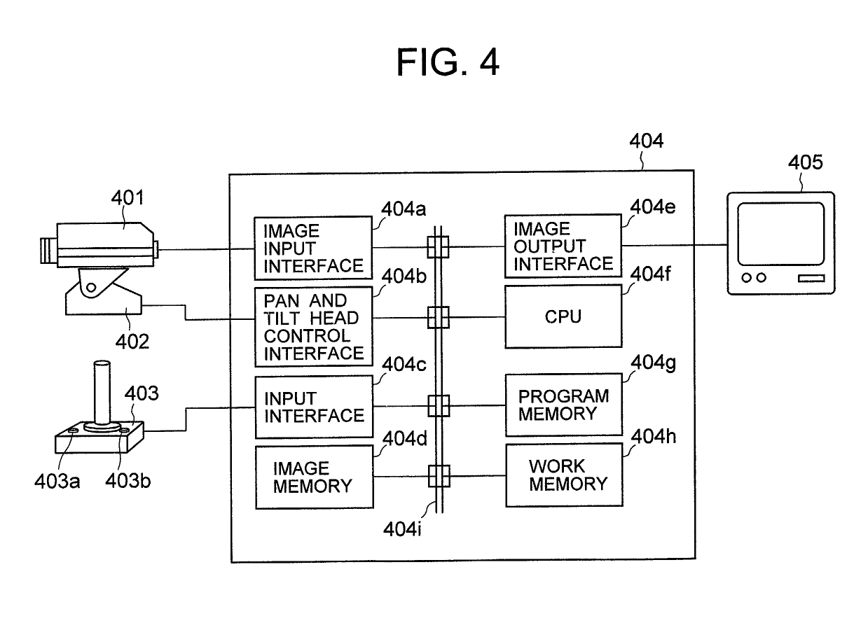

FIG. 4 shows one embodiment of an intruding object monitoring system according to the present invention. FIG. 4 is a block diagram showing the hardware configuration of an image picking-up apparatus' view-field control apparatus. The numeral 401 indicates an image picking-up apparatus such as a camera (hereinafter called a camera), the numeral 402 indicates an image picking-up apparatus' view-field control apparatus (hereinafter called a camera pan and tilt head), such as a camera pan and tilt head, for changing the direction of the view field of the camera pan head of the camera 401, the numeral 403 indicates a manual manipulator 403, the numerals 403a and 403b indicate buttons (switches) on the manual manipulator 403, the numeral 404a indicates an image input interface, the numeral 404b indicates a pan and tilt head control interface, the numeral 404c indicates an input interface, the numeral 404d indicates an image memory, the numeral 404e indicates an image output interface, the numeral 404f indicates a CPU (Central Processing Unit), the numeral 404g indicates a program memory, the numeral 404h indicates a work memory, the numeral 404i indicates a data bus, the numeral 404 indicates an image picking-up apparatus' view-field control apparatus having at least the image input interface 404a, pan and tilt head control interface 404b, input interface 404c, image memory 404d, image output interface 404e, CPU 404f, program memory 404g, work memory 404h, and data bus 404i, and the numeral 405 indicates an output monitor.

In the hardware configuration shown in FIG. 4, the camera 401 is connected to the image input interface 404a, the camera pan and tilt head 402 is connected to the pan and tilt head control interface 404b, the manual manipulator 403 is connected to the input interface 404c, and the output monitor 405 is connected to the image output interface 404e. In addition, the image input interface 404a, pan and tilt head control interface 404b, input interface 404c, image memory 404d, image output interface 404e, CPU 404f, program memory 404g, and work memory 404h are connected to the data bus 404i.

The camera 401 shown in FIG. 4 picks up the image of an image pick-up view field. The camera 401 converts a picked-up video to electric signals (for example, NTSC video signals) and outputs the converted video signals to the image input interface 404a. The image input interface 404a converts the received video signals to image data in a format that can be processed by an intruding object monitoring system (for example, 640 pixels wide, 480 pixels high, 8 bits/pixel) and sends the image data to the image memory 404d via the data bus 404i. The image memory 404d accumulates therein the received image data. The manual manipulator 403 converts the manipulation direction and the states of the buttons 403a and 403b into electric signals (for example, contact signals) and outputs them to the input interface 404c. The input interface 404c converts the signals to manipulation data and outputs the data to the data bus 404i. The CPU 404f analyzes the signals (manipulation data) received from the input interface 404c and the image accumulated in the image memory 404d in the work memory 404h according to the program stored in the program memory 404g.

As a result of the above analysis, the control amount of the view field direction of the camera 401 is calculated. The CPU 404f controls the camera pan and tilt head 402 via the pan and tilt head control interface 404b. The pan and tilt head control interface 404b converts a control instruction from the CPU 404f into the control signals (for example, RS485 serial signals) for use by the camera pan and tilt head 402 and outputs them to the camera pan and tilt head 402. The camera pan and tilt head 402 controls the pan motor and the tilt motor according to the control signal from the pan and tilt head control interface 404b to change the camera view field angle. In addition, the CPU 404f draws (superposes) the manipulation pointer on the input image, stored in the image memory 404d, based on the manipulation pointer position stored in the work memory 404h and displays the camera image on the output monitor 405 via the image output interface 404e. The image output interface 404e converts the signals from the CPU 404f to a format that can be used by the image output interface 404e (for example, NTSC video signals) and sends them to the display monitor 405. The display monitor 405 displays the camera video.

Although, in the embodiment shown in FIG. 4, an image picking-up apparatus' view-field control apparatus that changes the view field direction of the image picking-up apparatus is used as a camera pan and tilt head controller, an intruding object detection processing program including the above-described operation program may be saved in the program memory 404g to provide the intruding object detecting function. Another operation may also be added. Of course, it is also possible that the above-described operation program may be stored on a computer-readable recording medium.

The embodiments described below are executed in the hardware configuration shown in FIG. 4 that is one example of the hardware configuration of an image picking-up apparatus' view-field control apparatus. Also, in the embodiments, an image used is described as 640 pixels wide, 480 pixels high, and 8 bits per pixel. Of course, the same operation is executed using an image of other number of pixels.

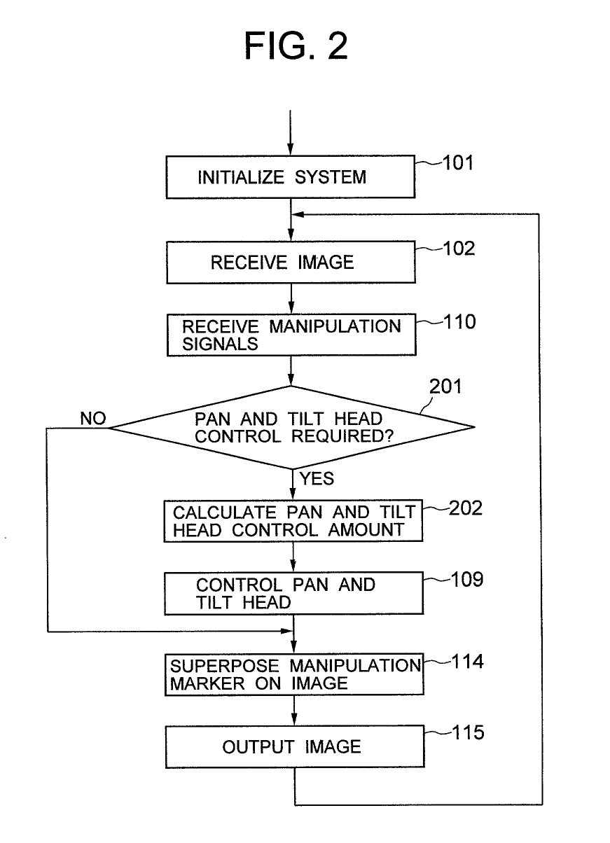

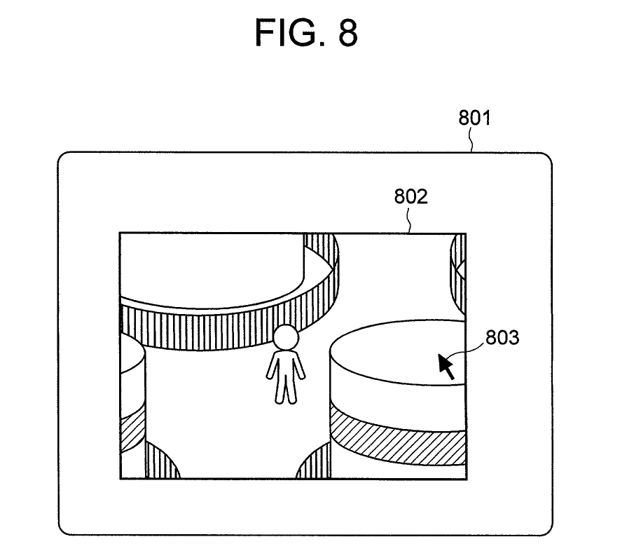

With reference to FIG. 2 and FIG. 8, a first embodiment of the present invention will be described. FIG. 2 is an example of a flowchart showing the processing operation of one embodiment of the present invention. FIG. 8 is a diagram showing an example of the screen of a display, such as a monitor, according to the present invention. This figure shows the overview of an onscreen operation on the camera pan and tilt head manipulation apparatus. When the operator uses the manual manipulator 403 in the first embodiment, the control amount of the camera pan and tilt head 402 is calculated based on the manipulation signal entered via the input interface 404c and the camera pan and tilt head 402 is controlled via the pan and tilt head control interface 404b.

In FIG. 8, a camera video 802 is displayed over almost a whole of the display screen (manipulation screen 801) of the output monitor 405, and a manipulation marker 803, which moves on the screen according to the manipulation through the manual manipulator 403, is superposed on the camera video 802. The “manipulation marker” is a manipulation pointer or an indicia that is displayed on the screen for specifying a particular portion of the camera video.

In FIG. 2, when the apparatus is started, all means 404a-404i included in the image picking-up apparatus' view-field control apparatus 404 are initialized in the system initialization step 101. The position coordinates (x, y) (coordinate system with the upper-left corner being (0, 0) and with the pixel of the manipulation screen being 1) of the manipulation marker 803 are set, for example, to a center of a display screen in the manipulation screen (x=320, y=240).

Next, in the image receiving step 102, an input image is received from the camera 401 via the image input interface 404a.

Then, in the manipulation signal receiving step 110, the manipulation direction of the manual manipulator 403 (for example, an angle at which the joystick is tilted) and the state of manipulation buttons 403a and 403b (for example, if the manipulation buttons 403a and 403b are on or off) are received. If a manipulation signal is received in the manipulation signal receiving step 110, the position coordinates (x, y) of the manipulation marker 803 are changed according to the manipulation direction, where 0≦x<640 and 0≦y<480.

Next, in the pan and tilt head control checking step 201, a check is made if the camera pan and tilt head 402 must be controlled. For example, a check is made for the state of the manipulation button 403a received in the manipulation signal receiving step 110. If the manipulation button 403a is on, control is passed to the pan and tilt head control amount calculating step 202 judging that the camera pan head 402 must be controlled; if the manipulation button 403a is off, control is passed to the manipulation marker superimposing step 114 judging that the camera pan and tilt head 402 need not be controlled.

Although, in the embodiment described above, whether the camera pan and tilt head 402 must be controlled is checked by whether the manipulation button 403a is on or off, it is also possible to determine that the camera pan and tilt head 402 must be controlled if the state of the manipulation button 403b is on or if both the manipulation buttons 403a and 403b are pressed at the same time (both on).

Another checking method used in the pan and tilt head control necessity checking step 201 is as follows. The offset dx in the x-axis direction (hereinafter referred to as “x-direction offset”) and the offset dy in the y-axis direction (hereinafter referred to as “y-direction offset”) of the position coordinates of the manipulation marker 803 relative to the center (320, 240) of the camera video 802 are calculated from expression (1).

$$\begin{matrix}dx = x - {x}_{0} \\ dy = y - {y}_{0}\end{matrix} \} \qquad Expression ( 1 )$$

It may be determined that the camera pan and tilt head 402 must be controlled if the absolute value of the x-direction offset |dx|>T or if the absolute value of the y-direction offset |dy|>T, where T is a predetermined threshold for controlling the camera pan and tilt head 402, for example, T=64 (10% of image width).

Next, in the pan and tilt head control amount calculating step 202, the control amount (control direction and control speed) of the camera pan and tilt head 402 is calculated. The control direction is determined by the offsets dx and dy relative to the center of the camera video 802 according to the expression (1). That is, for the x direction, if dx<-T, the pan motor is controlled such that the camera view field 506 is moved in the left direction; if dx>T, the pan motor is controlled such that the camera view field 506 is moved in the right direction. Similarly, for the y direction, if dy<-T, the tilt motor is controlled such that the camera view field 506 is moved in the downward direction; if dy>T, the tilt motor is controlled such that the camera view field 506 is moved in the upward direction.

In addition, the control speeds (sx, sy) of the pan motor and the tilt motor are calculated from expression (2):

$$\begin{matrix}sx = \frac{dx}{\frac{640}{2}} \cdot M \\ sy = \frac{dy}{\frac{480}{2}} \cdot M\end{matrix} \} \qquad Expression ( 2 )$$

In expression (2), M represents the predetermined maximum control speed of the camera pan and tilt head control amount, for example, 40°/sec. According to expression (2), the control speed of 0°-40°/sec may be obtained based on the offset of the position coordinates of the manipulation marker 803 relative to the center of the camera video 802.

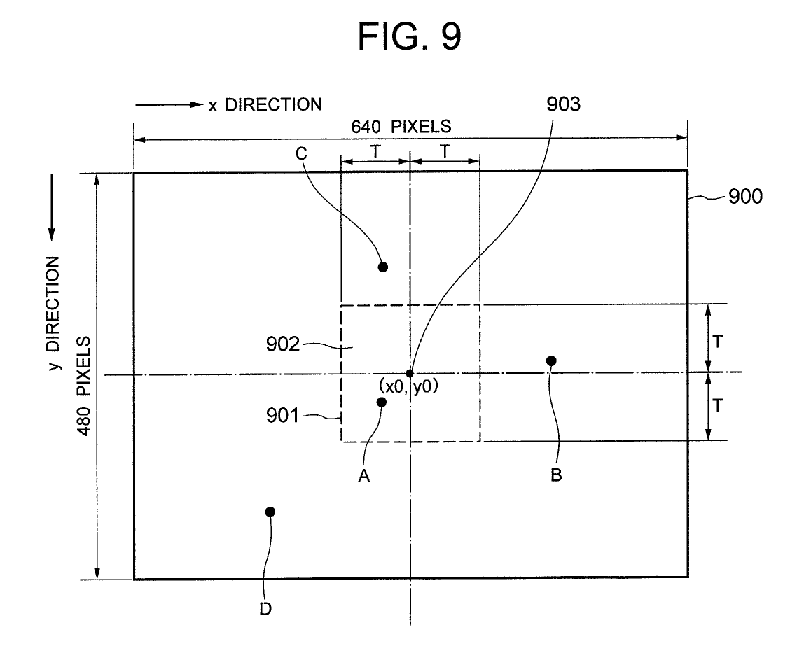

FIG. 9 is a diagram schematically showing an example of the relation between the position of the manipulation marker 803 in the camera video 802 displayed on the display monitor 405 (when the manipulation button 403a is on) and the control direction and control speed. For brevity, it is assumed that the threshold T=40 and that the maximum control speed M=40°/sec.

In FIG. 9, a camera video image 900 is displayed on the display monitor 405. An actual video image, which is not necessary for the description, is not displayed but only the screen frame is shown. The horizontal direction is the x-direction, and the vertical direction is the y-direction. Points A-D indicate the positions of the manipulation marker 803 when the manipulation button 403a is on (In practice, all points A-D are not displayed at a time but only one of them is displayed as the manipulation marker 803 moves). An area 902 enclosed by a broken line 901 indicates an area whose absolute value of the x-direction offset and that of the y-direction offset relative to the position (x₀, y₀), which is the center (origin) 903 of the camera video image 900, are smaller than the threshold T (|dx|≦T and |dy|≦T).

When the manipulation marker 803 is at position A, both the absolute value of x-direction offset and that of the y-direction offset are smaller than the threshold T. Therefore, even if the manipulation button 403a is on, it is determined that the camera pan and tilt head 402 need not be controlled and control is passed to the manipulation marker superimposing step 114. However, if the manipulation marker 803 is outside the frame 901 (for example, any one of points B-D) and the manipulation button 403a is on, it is determined that the camera pan and tilt head 402 must be controlled. In this case, control is passed to the pan and tilt head control amount calculating step 202 to calculate the control amount (control direction and control speed) of the camera pan and tilt head 402. For example, if point B is at (x=x₀+160 (=480), y=y₀−10 (230)), then |dx|>T and |dy|≦T and therefore the control direction is determined by expression (1) to be the right direction. Similarly, if point C is at (x=x₀−20 (=300), y=y₀−120 (=120)), then |dx|≦T and |dy|>T and therefore the control direction is determined to be the upward direction. Similarly, if point D is at (x=x₀−160 (=160), y=y₀+160 (=400)), then |dx|>T and |dy|>T and therefore the control direction is determined to be the left direction and the downward direction.

In addition, in the pan and tilt head control amount calculating step 202, the control speed is changed, for example, by expression (2) according to the position of the manipulation marker 803. For example, if the marker is at point B and the manipulation button 403a is on, the control speed of the pan motor is sx=20°/sec. Similarly, the control speed of the tilt motor is sy=20°/sec at point C. Similarly, the control speed of the pan motor is sx=20°/sec, and the control speed of the tilt motor is sy=27°/sec at point D.

Next, in the pan and tilt head control step 109, the camera pan and tilt head 402 is controlled via the pan and tilt head control interface 404b based on the control amount (control direction and control speed of the pan motor and the tilt motor) obtained in the pan and tilt head control amount calculating step 202.

In the manipulation marker superimposing step 114, an output image, which is produced by super-imposing the manipulation marker 803 on the input image based on the position coordinates of the manipulation marker 803, is generated.

In the image output step 115, the output image generated in the manipulation marker super-imposing step 114 is output, for example, to the display monitor 405 via the image output interface 404e.

Therefore, when the operator manipulates the manual manipulator in the above embodiment, the manipulation marker 803 moves according to the manipulation, the control amount of the camera pan and tilt head 402 is calculated based on the position coordinates, and the camera view-field direction may be changed.

In the above embodiment, the threshold T is the same for the x-direction and the y-direction. However, it is apparent that the threshold T may be different between the x-direction and the y-direction. In addition, although the offset relative to the center of the camera video 802 is calculated, the offset relative not only to the center but also to any position may be calculated.

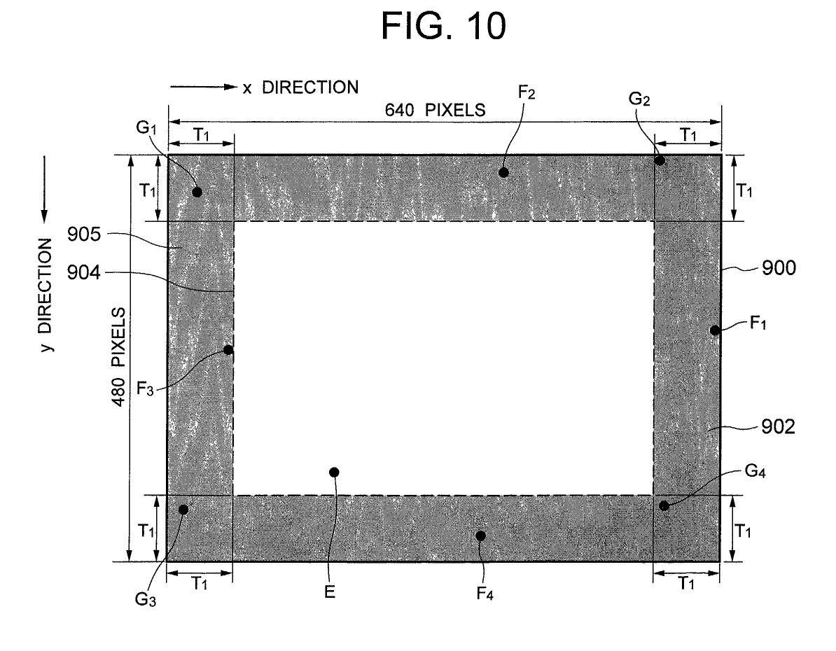

The method described as the checking method in the pan and tilt head control checking step 201, with reference to FIG. 9, in the above embodiment is as follows. That is, the x-direction offset dx and the y-direction offset dy of the position coordinates of the manipulation marker 803 relative to the center of the camera video 802 (in this example, (x₀, y₀)) are calculated from expression (1). If the absolute value of the offset is larger than a predetermined threshold T, it is judged that the camera pan and tilt head 402 must be controlled and, in the pan and tilt head control amount calculating step 202, the control amount is also calculated based on the distance from the center. Alternatively, another checking method may also be used. For example, as shown in FIG. 10, whether or not the pan and tilt head must be controlled may be judged, and the pan and tilt head control amount may be calculated, based on the distance from the end of the camera video 802.

FIG. 10 is a diagram schematically showing an example of the relation between the position of the manipulation marker 803 on the camera video 802 displayed on the display monitor 405 (when the manipulation button 403a is on) and the control direction and the control speed.

Referring to FIG. 10, the camera video image 900 is displayed on the display monitor 405. An actual video image, which is not necessary for the description, is not displayed but only the screen frame is shown. The horizontal direction is the x-direction, and the vertical direction is the y-direction. Points E, F1-F4, and G1-G4 indicate the positions of the manipulation marker 803 when the manipulation button 403a is on (In practice, all points E, F1-F4, and G1-G4 are not displayed at a time but only one of them is displayed as the manipulation marker 803 moves). The area (filled display area) 902 between a broken line 904 and the screen frame of the camera video image 900 indicates an area extending inward from the end of the screen by a predetermined number of pixels, T₁, in the x-direction and in the y-direction, respectively.

When the manipulation marker 803 is at point E, both absolute value of the offset in the x-direction and that of the offset in the y-direction are at least a predetermined threshold T₁ (for example, 80 pixels) away from the end of the screen. Therefore, even if the manipulation button 403a is on, it is judged that the camera pan and tilt head 402 need not be controlled and control is passed to the manipulation marker superimposing step 114. However, if the manipulation button 403a is on when the manipulation marker 803 is outside the broken line 904 (for example, one of points F₁-F₄ and G₁-G₄), it is judged that the camera pan and tilt head 402 must be controlled. In this case, control is passed to the pan and tilt head control amount calculating step 202 to calculate the control amount (control direction and control speed) of the camera pan and tilt head 402.

At this time, the control direction is the right direction if the manipulation marker is at point F₁. the upward direction if the manipulation marker is at point F₂, the left direction if the manipulation marker is at point F₃, and the downward direction if the manipulation marker is at point F₄. Also, when the manipulation marker is in a corner of the screen such as points G₁-G₄, the direction is, for example, the upper-left direction if the manipulation marker is at point G₁, the upper-right direction if the manipulation marker is at point G₂, the lower-left direction if the manipulation marker is at point G₃, and the lower-right direction if the manipulation marker is at point G₄. Whether or not the manipulation marker is in a corner of the screen is checked by examining if the manipulation marker 803 is within the predetermined value T₁ from the neighboring two ends of the screen and, if so, it is determined that the manipulation marker is in a corner.

In addition, although the control speed at this time may be a predetermined constant speed, it may be changed according to the distance from the end of the screen by using expression (2). For example, the speed may be calculated as shown in expression (3).

$$\begin{matrix}sx = \frac{( {T}_{1} - \vert xB - x \vert )}{{T}_{1}} \cdot M \\ sy = \frac{( {T}_{1} - \vert yB - y \vert )}{{T}_{1}} \cdot M\end{matrix} \} \qquad Expression ( 3 )$$

In this case, when the manipulation marker is at the right end, for example, at point F₁ (coordinates (635, 220)), the control speed sx of the pan motor is calculated as sx=38°/sec from expression (3) with the right end (XB=639) of the camera video image 900 as the base, where the threshold T₁=80 and the maximum control speed M=40°/sec. Because point F₁ is at least T₁ away from the top end and the bottom end, the tilt motor is not controlled. Similarly, when the manipulation marker is at the top end, for example, at point F₂, sy is calculated from expression (3) with the top end (yB=0) as the base. Similarly, when the manipulation marker is at the left end, for example, at point F₃, sx is calculated from expression (3) with the left end (xB=0) as the base. When the manipulation marker is at the bottom end, for example, at point F₄, sy is calculated from expression (3) with the bottom end (yB=479) as the base.

Although the control speed is calculated based on the distance from the end of the screen in the description of the above embodiment, the control speed may be calculated with the origin set at any position. For example, the control speed may be calculated so that it is proportional to the distance from the center of a side or from the center of the screen.

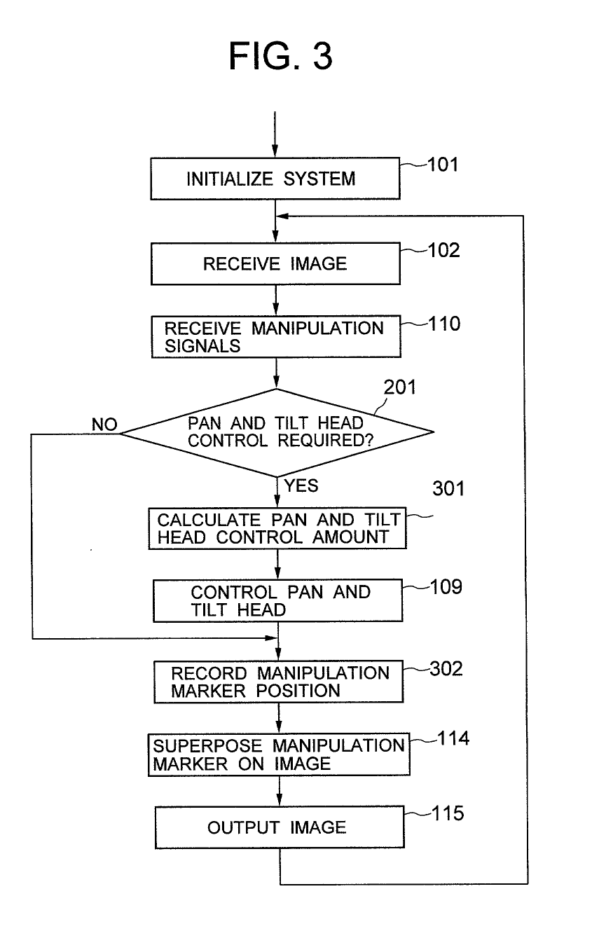

With reference to FIG. 3, a second embodiment of the present invention will be described. FIG. 3 is an example of a flowchart showing the processing operation of the second embodiment of the present invention. In the second embodiment, the control speed of the camera pan and tilt head 402 is adjusted according to the operator's (past or immediately preceding) manipulation state tilnow when the control amount of the camera pan and tilt head is calculated. The flowchart in FIG. 3 is similar to that in FIG. 2 except that the pan and tilt head control amount calculating step 202 is replaced with the pan and tilt head control amount calculating step 301 and, in addition, the manipulation marker position recording step 302 is added. The other steps are the same as those in FIG. 2 and, therefore, their description is omitted.

If it is judged, in the pan and tilt head control checking step 201 of the processing operation shown in FIG. 3, that the camera pan and tilt head 402 must be controlled, the control speed of the camera pan and tilt head 402 is calculated in the pan and tilt head control amount calculating step 301 based on the position (x30, y30) of the manipulation marker 803 recorded in the work memory 404h and the position (x, y) of the current manipulation marker 803, wherein the position (x30, y30) is the position of the manipulation marker displayed in the frame a predetermined number of frames before (for example, 30 frames (corresponding to one second) before). In the description, (xn, yn) represents the position coordinates of the manipulation marker that is n frames before. The control direction is the same as that in the first embodiment of the present invention.

The control speed at this time is calculated from expression (4).

$$\begin{matrix}sx = \frac{\vert x - x30 \vert}{640} \cdot M \\ sy = \frac{\vert y - y30 \vert}{480} \cdot M\end{matrix} \} \qquad Expression ( 4 )$$

Like expression (2), M in expression (4) represents a predetermined maximum control speed of the camera pan and tilt head, for example, 40°/sec. Expression (4) gives the control speed of 0°-40°/sec based on the operator's manipulation speed of the manipulation marker 803. Although the control speed is calculated in this embodiment based on the position (x30, y30) of the manipulation marker 803 that is 30 frames before and the position (x, y) of the current manipulation marker 803, the number of frames other than 30 may be used as long as the time interval may be used to calculate the movement amount of the manipulation marker 803.

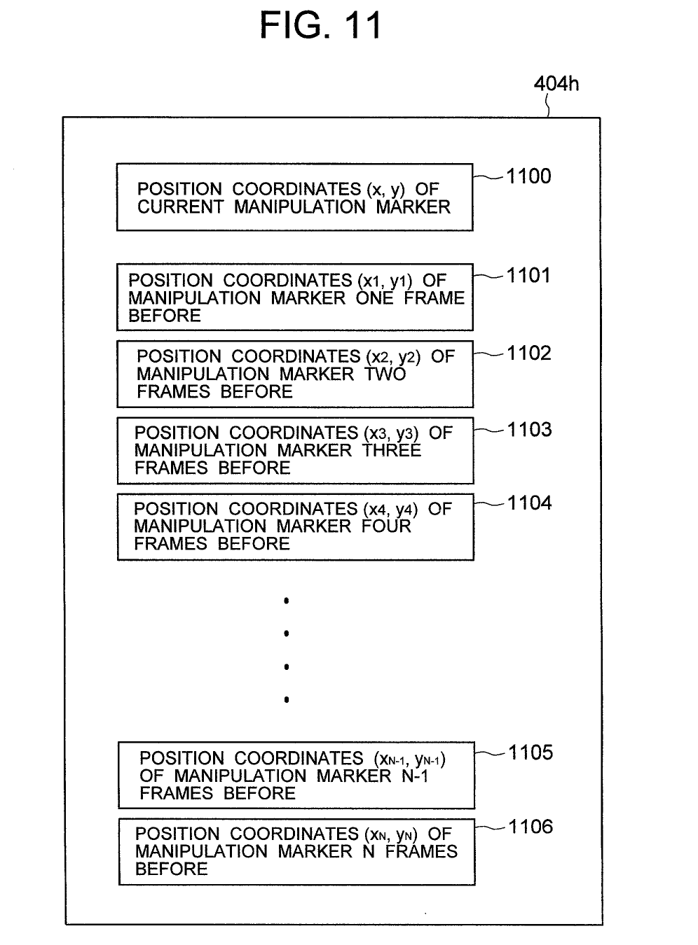

Next, in the manipulation marker position recording step 302, the history of the position coordinates of the manipulation marker 803 recorded in the work memory 404h is updated. This processing is described with reference to FIG. 11.

FIG. 11 shows how the position coordinates (x, y) of the current manipulation marker 803 and a predetermined number of last frames' position coordinates (xi, yi) (i=1−N) of the manipulation marker 803 are recorded in the work memory 404h. In FIG. 11, data other than the position coordinates of the manipulation marker recorded in the work memory 404h are omitted. In the manipulation marker position recording step 302, the position coordinates (xj, yj) of the manipulation marker that is j frames before is replaced with the position coordinates (xj−1, yj−1) of the manipulation marker that is j−1 frames before. This operation is executed j=N−1 times. Next, the position coordinates (x1, y1) 1101 of the manipulation marker that is one frame before is replaced with the position coordinates (x, y) 1100 of the current manipulation marker. That is, the position coordinates (x, y) 1100 of the current manipulation marker become the position coordinates (x1, y1) 1101 of the manipulation marker that is one frame before, the position coordinates (x, y) 1101 of the manipulation marker that is one frame before become the position coordinates (x2, y2) 1102 of the manipulation marker that is two frames before, and after that, the position coordinates of each manipulation marker are shifted one frame and then stored. The position coordinates (xN, yN) 1106 of the oldest manipulation marker that is N frames before are discarded. In this way, the history of position coordinates of the manipulation marker 803 of last N frames is recorded in the work memory 404h. Note that N may be any number equal to or larger than the number of frames used to calculate the movement amount of the manipulation marker 803 in the pan and tilt head control amount calculating step 301.

Therefore, in this embodiment, when the operator manipulates the manual manipulator, the manipulation marker 803 moves as he or she performs manipulation. The control direction of the camera pan and tilt head is calculated based on the position coordinates of the manipulation marker, and the control speed of the camera pan and tilt head is calculated based on the movement speed of the manipulation marker 803. As a result, the camera view field direction may be changed.

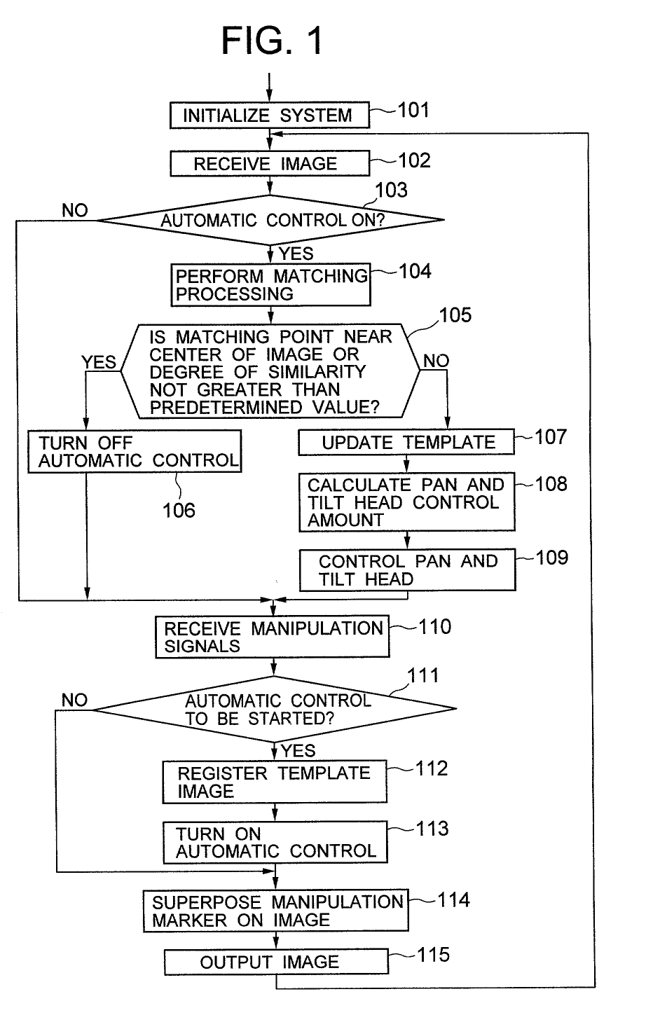

With reference to FIG. 1, a third embodiment of the present invention will be described. FIG. 1 is an example of flowchart showing the processing operation of the third embodiment of the present invention. In the third embodiment, the direction of view field of the camera pan and tilt head 402 is automatically controlled (this is called automatic control mode) so that the part of the camera video 802 in the position coordinates of the manipulation marker 803 is positioned in the center of the camera view field 506 when the manipulation button 403a is pressed.

First, as in the flowchart of the second embodiment shown in FIG. 3, the system is initialized in the system initialization step 101, an input image is received in the image receiving step 102, and the manipulation direction of the manual manipulator 403 and the state of the manipulation buttons 403a and 403b are received in the manipulation signal receiving step 110. Note that, in this embodiment, the processing described below is performed between the image receiving step 102 and the manipulation signal receiving step 110.

That is, in the automatic control judging step 103 that follows the image receiving step 102, a check is made if the intruding object monitor apparatus is in the automatic control mode. If the apparatus is in the automatic control mode, control is passed to the matching processing step 104. If the apparatus is not in the automatic control mode, control is passed to the manipulation signal receiving step 110.

In the matching processing step 104, the template image (described below) recorded in the image memory 404d is matched with the template of the input image received in the image receiving step 102 to search for a part that is most similar to the template image in the received input image.

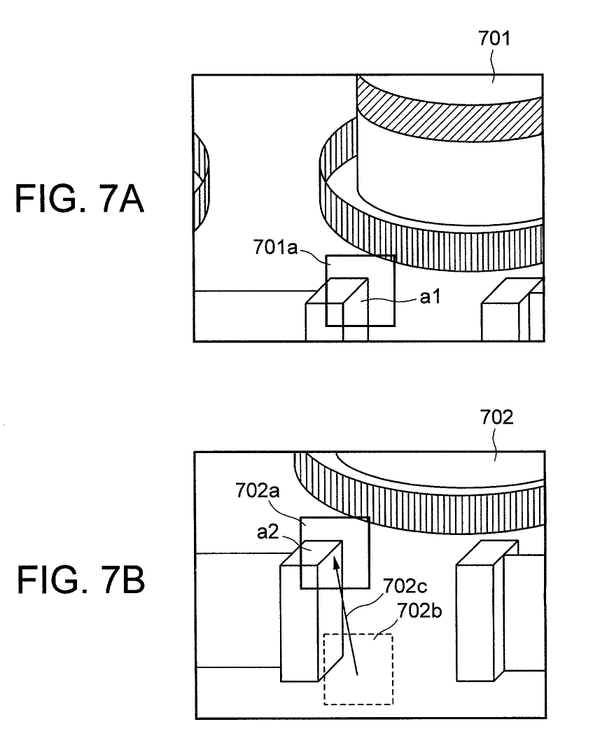

With reference to FIGS. 7A and 7B, template matching processing will be described. FIGS. 7A and 7B are diagrams showing the template matching method applied to the present invention.

In FIG. 7A, a camera video (image) 701 represents an input image when a template is registered, and an area 701a represents the area of the template image (a1) that is selected from the image 701 for registration. The positions of the image 701, the template image (a1), and the area of the template image (a1) are recorded in the image memory 404d.

Next, in FIG. 7B, the apparatus searches a camera video (image) 702, obtained at a time different from the time the image 701 was obtained, for the area of a partial image most similar to the template image (a1) and obtains an area 702a. The center of this area is called a matching position. An area 702b of the image 702 represents the same position as that of the area 701a, and an arrow 702c connects the center of the area 702b with the center of the area 702a. Therefore, as a result of template matching, it is understood that the area 701a has moved to the area 702b with the movement amount indicated by the arrow 702c. This template matching method is described, for example, in “Introduction to Computer Image Processing” by Hideyuki Tamura, pages 149-153, Souken Shuppan, 1985, and is widely used as a basic image processing method of image processing.

Next, in the automatic control end checking step 105, if the matching position obtained in the matching processing step 104 is within a predetermined value from the center of the camera video or if the degree of similarity is equal to or smaller than the predetermined value, control is passed to an automatic control end step 106; otherwise, control is passed to the template updating step 107.

To check whether or not the matching point is within the predetermined value from the center of the camera video, the amount of movement from the area 701a to the area 702a is calculated from expression (5) using the coordinates (mx, my) of the center of the area 702a obtained through template matching and the coordinates of the center ((x₀, y₀) in this example) of the camera image 702.

$$\begin{matrix}dx = mx - {x}_{0} \\ dy = my - {y}_{0}\end{matrix} \} \qquad Expression ( 5 )$$

where, dx is the movement amount in the x-direction and dy is the movement amount in the y-direction.

The movement amount is calculated from expression (5) and, if the movement amount in the x-direction is |dx|≦T and if the movement amount in the y-direction is |dy|≦T, it is judged that the matching position is within a predetermined value from the center of the camera image.

Next, to check whether or not the degree of similarity is equal to or smaller than a predetermined value, the degree of similarity is calculated as follows. That is, the average of the differences between the pixel values of the template image and those of the area of a partial image in the matching position is calculated. If the average of the differences is 20 or larger (the pixel value is 0-255 assuming that one pixel is eight bits), it is judged that the degree of similarity is equal to or smaller than the predetermined value.

Next, the automatic control mode is released in the automatic control end step 106 and control is passed to the manipulation signal receiving step 110.

Also, in the template updating step 107, the template image (a1) recorded in the image memory 404d is replaced by the image (a2) of the area 702a obtained through template matching.

Next, in the pan and tilt head control amount calculation step 108 and the pan and tilt head control step 109, the same processing as those in the pan and tilt head control amount calculating step 202 and the pan head control step 109 in the first embodiment of the present invention shown in FIG. 2 is performed. That is, the control amount (control direction and control speed) of the camera pan and tilt head 402 is calculated using expression (1) and expression (2) to control the camera pan and tilt head 402.

In the manipulation signal receiving step 110, the same processing as that in the manipulation signal receiving step 110 in the first embodiment shown in FIG. 2 is performed to obtain the manipulation direction of the manual manipulator 403 and the state of the buttons 403a and 403b manipulated by the operator.

Next, in the automatic control start checking step 111, a check is made whether automatic control is to be started. For example, if the manipulation button 403a on the manual manipulator 403 is pressed, control is passed to the template image registering step 112 judging that automatic control is to be started. If the manipulation button is not pressed, control is passed to the manipulation marker superimposing step 114.

In the template image registering step 112, a predetermined area (for example, 30×30 pixels), with the position of the manipulation marker 803 when the button switch 403a is pressed as the center of the area, is registered with the image memory 404d as an template image (a1). In addition, in the automatic control start step 113, the automatic control mode is started. Next, in the manipulation marker super-imposing step 114 and the image output step 115, the manipulation marker 803 is superposed on the input image and the video is output, as in the manipulation marker superimposing step 114 and the image output step 115 in the first embodiment of the present invention shown in FIG. 2, and the image is displayed on the display monitor 405 via the image output interface 404e.

Although the start of the automatic control mode is judged in this embodiment by whether the manipulation button 403a on the manual manipulator 403 is pressed, the automatic control mode may be started by some other input such as a special voice, an operator's body gesture or hand gesture and direction of eyes. Therefore, according to this embodiment, the camera pan and tilt head may be controlled automatically so that the video in the operator-specified position is displayed in the center of the camera video.

Although a joystick is used as the automatic manipulator in all the embodiments of the present invention described above, it is apparent that any standard pointing device used on a personal computer may be used if the pointing device is able to move the manipulation marker on the screen for pointing to an object in at least one of the directions, upward, downward, left, right, and oblique. For example, when a mouse is used as the manipulator, pressing the manipulation button 403a is made equivalent to a left click and pressing the manipulation button 403b is made equivalent to a right click.

Although the image picking-up apparatus' view field control apparatus and the manipulator are separately configured as separate units, the manipulator may be included in the image picking-up apparatus' view field control apparatus.

In addition, the image picking-up apparatus view field control apparatus according to the present invention, capable of automatically following a moving object and image picking up the same, may be widely used not only in monitoring but also in video recording, news covering, and movie making.

Therefore, the apparatus in the above embodiments allows the operator to change the camera view field by changing the control amount of the pan motor and the tilt motor of a camera pan and tilt head though an easy operation and, in addition, to automatically control the camera pan and tilt head so that a particular part may be brought into the center of the camera video, thus significantly increasing operability and greatly expanding the range of applications of the image picking-up apparatus view field control apparatus.

It should be further understood by those skilled in the art that the foregoing description has been made on embodiments of the invention and that various changes and modifications may be made in the invention without departing from the spirit of the invention and the scope of the appended claims.

What is claimed is:

1. A method for controlling a view field control apparatus of an image picking-up system including an image picking-up apparatus for image picking up an object, a driving mechanism for driving said image picking-up apparatus, a manipulator for controlling a view field of said image picking up apparatus, a display unit and a controlling unit, said method comprising the steps of:
image picking up said object;
manipulating said manipulator to drive said image picking-up apparatus;
displaying a manipulation marker in superposition on said image picked up by said image picking-up apparatus on said display unit, said manipulation marker being manipulated by said manipulator; and
driving said driving mechanism in response to a movement of said manipulation marker, wherein the view field of said image picking-up apparatus is controlled by manipulation of said manipulator.

2. The method according to claim 1, wherein said step of image picking up said object includes the step of converting an image signal supplied from said image picking-up apparatus to image data, and, said step of driving said driving mechanism in response to a movement of said manipulation marker includes the steps of calculating a control amount for movement of said image picking-up apparatus based on positional coordinates of said manipulation marker and controlling said driving mechanism based on a calculation result.

3. The method according to claim 2, wherein said step of driving said driving mechanism in response to the movement of said manipulation marker includes the step of setting a predetermined threshold value for driving said driving mechanism and the step of driving said driving mechanism when a control amount calculation result for movement of said image picking-up apparatus exceeds said predetermined threshold value.

4. The method according to claim 3, further comprising the step of displaying said predetermined threshold value on said display unit as area information.

5. The method according to claim 2, further comprising the step of controlling such that said manipulation marker manipulated by said manipulator is located at around a center of a display screen of said display unit in initial setting.

6. The method according to claim 2, further comprising the step of controlling a driving speed of said driving mechanism in response to a movement distance of said manipulation marker manipulated by said manipulator.

7. The method according to claim 2, wherein said step of image picking up said object includes the step of storing a predetermined image obtained from said image picking-up apparatus in a storage, as a template image, said predetermined image being designated by said manipulation marker, wherein said step of driving said driving mechanism in response to the movement of said manipulation marker includes the steps of detecting coordinates of that part of a predetermined image subsequently obtained from said image picking-up apparatus which is most similar to said template image, calculating a control amount for movement of said image picking-up apparatus based on said detected coordinates and, based on a calculation result, controlling said driving mechanism.

8. A view field control apparatus of an image picking-up apparatus comprising:
an image picking-up apparatus for image picking-up an object;
a manipulator for controlling a view field of said image picking-up apparatus;
a display unit for displaying an image from said image picking-up apparatus; and
a control unit for controlling said image picking-up apparatus, driving mechanism and display unit, wherein said control unit displays a manipulation marker manipulated by said manipulator in superposition on an image from said image picking-up apparatus and said driving mechanism is driven in response to a movement of said manipulation marker to thereby control the view field of said image picking-up apparatus.

9. The view field control apparatus according to claim 8, wherein said control unit includes an image data conversion unit and an image processing unit, wherein said image data conversion unit converts an image signal supplied from said image picking-up apparatus to image data, said image processing unit calculates a control amount for movement of said image picking-up apparatus based on positional coordinates of said manipulation marker, and said control unit controls said driving mechanism based on the calculation result.

10. The view field control apparatus according to claim 9, wherein said control unit has a means for setting a predetermined threshold value for driving said image picking-up apparatus, wherein when the control amount calculation result exceeds said predetermined threshold value, said control unit drives said driving mechanism.

11. The view field control apparatus according to claim 9, said predetermined threshold value is displayed on said display unit as area information.

12. The view field control apparatus according to claim 9, wherein said control unit controls such that said manipulation marker manipulated by said manipulator is located around a center of a display screen of said display unit in initial setting.

13. The view field control apparatus according to claim 9, wherein said manipulator is operable with at least one of operator's voice, body gesture, hand gesture and glance direction.

14. The view field control apparatus according to claim 9, wherein said image processing unit stores a predetermined image obtained from said image picking-up apparatus in a storage, as a template image, said predetermined image being designated by said manipulation marker, detects positional coordinates of that part of a predetermined image subsequently obtained from said image picking-up apparatus which is most similar to said template image, calculates a control amount for movement of said image picking-up apparatus based on said positional coordinates and, based on a calculation result, controls said driving mechanism.

15. A computer program product comprising:
a computer usable medium having computer readable program code means embodied therein for controlling a view field control apparatus of an image picking-up system including an image picking-up apparatus for image picking-up an object, a driving mechanism for driving said image picking-up apparatus, a manipulator for controlling a view field of said image picking-up apparatus, a display unit and a control unit, said computer readable program code means comprising: means for image picking-up an object by said image picking-up apparatus and converting an image signal supplied from said image picking-up apparatus to image data;
means for receiving a signal from a manipulator for controlling a view field of said image picking-up apparatus to drive said image picking-up apparatus;
means for displaying an image picked up by said image picking-up apparatus and a manipulation marker superposed on said image, said manipulation marker being manipulated by said manipulator;
means for calculating a control amount for movement of said image picking-up apparatus based on positional coordinates of said manipulation marker and, based on the calculation result, driving said driving mechanism.

16. The computer program product according to claim 15, wherein said means for driving said driving mechanism in response to a movement of said manipulation marker includes means for setting a predetermined threshold value for driving said driving mechanism and means for driving said driving mechanism when a control amount calculation result exceeds said predetermined threshold value.

17. The computer program product according to claim 16, further comprising means for controlling such that said manipulation marker manipulated by said manipulator is located around a center of a display screen of said display unit in initial setting.

18. The computer program product according to claim 16, further comprising means for controlling a driving speed of said driving mechanism in response to a movement distance of said manipulation marker manipulated by said manipulator.

19. The computer program product according to claim 15, wherein said means for image picking-up an object by said image picking-up apparatus further includes means for storing a predetermined image obtained from said image picking up apparatus in a storage, as a template image, said predetermined image being designated by said manipulation marker, wherein said means for driving said driving mechanism in response to a movement of said manipulation marker includes the means for detecting positional coordinates of that part of a predetermined image subsequently obtained from said image picking-up apparatus which is most similar to said template image, calculating a control amount for movement of said image picking-up apparatus and, based on a calculation result, controlling said driving mechanism.
